(19) United States
(12) Patent Application Publication
(10) Pub. No.: US 2008/0113320 A1
(43) Pub. Date: May 15, 2008

(54) MOTOR DRIVEN GLOBE

(76) Inventor: Harold G. Middleton, Normandy Park, WA (US)

Correspondence Address: DAVIS WRIGHT TREMAINE, LLP/Seattle, 1201 Third Avenue, Suite 2200, SEATTLE, WA, 98101-3045, US

(21) Appl. No.: 11/874,090

(22) Filed: Oct. 17, 2007

Related U.S. Application Data
(60) Provisional application No. 60/865,383, filed on Nov. 10, 2006.

(51) Int. Cl. G09B 27/08; G09F 19/02

(52) U.S. Cl. 434/136; 40/414

(57) ABSTRACT

A motor driven globe disposed on a support surface. The globe includes a rotating globe shell and a rotation mechanism configured to rotate the shell about a vertical axis of rotation. The rotation mechanism includes a motor concealed inside the rotating shell and a support platform disposed on the support surface and substantially concealed inside a recess formed in an outside surface of the rotating shell. An output shaft aligned with the axis of rotation connects the motor inside the interior of the rotating shell to the support platform. The motor includes a motor body nonrotatably coupled to the interior of the rotating shell. Surface interaction forces between the support platform and support surface are greater than or equal to a rotational drive force generated by the motor and applied to the output shaft causing the motor body and the rotating shell coupled thereto to rotate about the output shaft.

### CROSS REFERENCE TO RELATED APPLICATION(S)

This application claims the benefit of U.S. Provisional Application No. 60/865,383, filed Nov. 10, 2006.

### BACKGROUND OF THE INVENTION

1. Field of the Invention

The present invention is directed generally to motor driven globes.

2. Description of the Related Art

Generally speaking, a globe is a sphere on which a map is displayed. The map may include a map of the earth (i.e., a terrestrial globe), a map of the heavens (i.e., a celestial globe), and the like. Many globes are rotationally mounted to a stand or base so that an observer can manually rotate the globe with respect to the stand and thereby view different portions of the map displayed on the globe. Motor driven globes include a motor that automatically rotates the globe.

Many people enjoy globes not only for their informational value but also for their aesthetic appeal. Therefore, novel globe designs and novel motor driven globe devices are desired. Further, motor driven globes that rotate without the need of a base or stand are also desirable. Additionally, a need exists for a motor driven globe having a rotation mechanism that is concealed by the globe itself and therefore does not detract from the aesthetic appeal of the globe or interfere with the information displayed by the globe.

### BRIEF DESCRIPTION OF THE SEVERAL VIEWS OF THE DRAWING(S)

FIG. 1 is a perspective view of an exemplary motor driven globe.

FIG. 2 is a fragmentary, cross-sectional elevational view of the motor driven globe of FIG. 1.

### DETAILED DESCRIPTION OF THE INVENTION

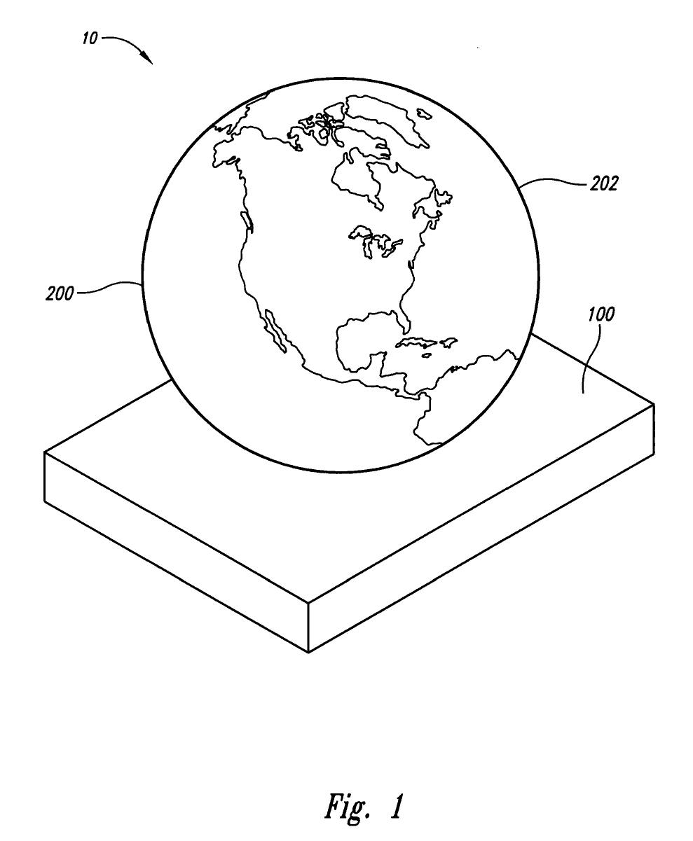

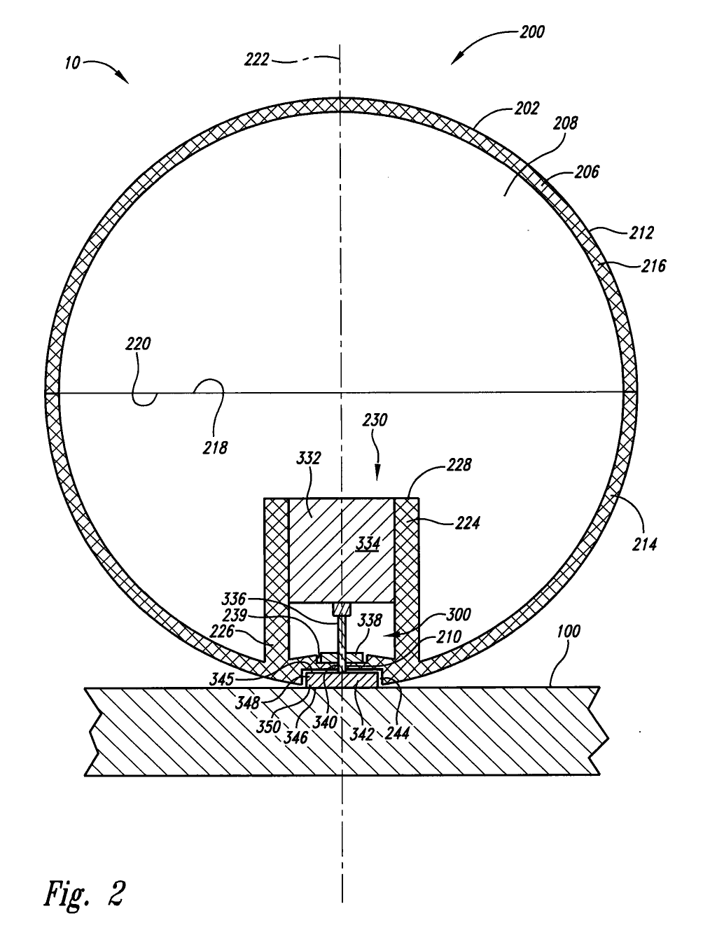

Referring to FIG. 1, a motor driven article or globe 10 is shown resting on a support surface 100, such as a top surface of a desk, a table, a shelf, and the like, and having a rotating globe shell 200 in the form of a globe shell. The globe 10 includes a novel rotation mechanism 300 (shown in FIG. 2) for rotating the global shell 200 on and relative to the support surface 100. The rotation mechanism 300 may be coupled to and housed inside the rotating globe shell 200. The rotating globe shell 200 is supported and rotated by the rotation mechanism 300 upon the support surface 100. The rotation mechanism 300 supports the rotating globe shell 200 upon the support surface 100 without direct attachment thereto and may be readily removed from the support surface 100 by simply lifting or sliding the rotating globe shell 200, and hence the rotation mechanism 300 coupled thereto, from the support surface 100.

While the rotating globe shell 200 depicted in the drawings has a generally spherical outer shape, the rotating globe shell 200 may have alternate outer shapes. Further, the rotating globe shell 200 may have an arbitrary outer shape. As non-limiting examples, the rotating globe shell 200 may be shaped to resemble a celestial object (e.g., planet, moon, star, satellite, etc.), or have a map of the constellations superimposed on a sphere, and the like. In the embodiment depicted in FIG. 1, the rotating globe shell 200 is shaped and decorated to resemble the earth. As is apparent to those of ordinary skill in the art, the invention is not limited by the shape and/or decorative elements selected for the rotating globe shell 200.

Aspects of the present invention provide the rotation mechanism 300 housed within the rotating globe shell 200 for transmitting rotational motion from an actuating element of the rotation mechanism 300 to the rotating globe shell 200. The rotation mechanism 300 which when assembled with the rotating globe shell 200, is substantially enclosed within it, and is substantially invisible from the exterior, giving the appearance that the rotating globe shell 200 is rotating seemingly without a motor drive or other means causing the rotation.

The seclusion or concealment of the rotation mechanism 300 substantially within the rotating globe shell 200 may provide a pleasing outer appearance uncluttered by the components of the rotation mechanism 300. Further, the motor driven globe 10 may attract and maintain the attention of observers as the rotating globe shell 200 rotates upon the support surface 100, seemingly without any source of rotational drive. Because the means of rotation is substantially invisible from the exterior, the motor driven globe 10 may evoke the curiosity of onlookers as they try to determine how the rotating globe shell 200 is able to rotate.

Referring to FIG. 2, the rotating globe shell 200 is shown in a cross-sectional elevational view. In various embodiments, the rotating globe shell 200 may include a housing 206 having the outside surface 202. The housing 206 includes an interior space 208 for housing the rotation mechanism 300. The housing 206 is supported and rotated by the rotation mechanism 300 upon the support surface 100 about a vertical axis of rotation 222, although other angled axes of rotation may be used.

The housing 206 may be constructed using any material known in the art including, for example, plastics, metals, wood, glass, Plexiglas, and any combination thereof. As one non-limiting example, the housing 206 may be constructed using injection molded plastics.

In various embodiments, the housing 206 may include two or more sub-members that may be disassembled to allow access to the components of the rotation mechanism 300 disposed in the interior space 208 of the housing 206. In alternate embodiments, the housing 206 may be constructed as a single unit or constructed using sub-members that are permanently assembled together. In various embodiments, the housing 206 may include a solid lower portion (not shown) and/or solid upper portion (not shown), one or both of which may include channels or voids for housing the various components of the rotation mechanism 300.

In the embodiment depicted in FIG. 2, the housing 206 includes the hollow portion 212 having a lower hollow portion 214 and an upper hollow portion 216. The lower hollow portion 214 and the upper hollow portion 216 may be releasably connected together at their open end portions 218 and 220, respectively.

While the rotating globe shell 200 depicted in FIG. 2 includes a lower hollow portion 214 and an upper hollow portion 216 that each comprise approximately half the hollow portion 212 of the rotating globe shell 200, it is apparent to those of ordinary skill in the art, that one of the lower hollow portion 214 and the upper hollow portion 216 may comprise more than half the hollow portion 212. The hollow portion 212 may be spherical or of any desired shape. As is apparent to those of ordinary skill, the shape of the hollow portion 212 may be determined by the desired shape of the rotating globe shell 200.

The housing 206 includes an aperture 210 located on the axis 222 and adjacent to the location where the rotation mechanism 300 rests upon the support surface 100. The aperture 210 allows one or more components of the rotation mechanism 300 inside the interior space 208 of the housing 206 to engage one or more components of the rotation mechanism 300 exterior to the interior space 208 of the housing 206. The rotation mechanism 300 may include a support platform 342 having an upper surface 345 and a lower surface 346. The support platform 342 may be located exterior to the interior space 208 of the housing 206. The lower surface 346 of the support platform 342 engages the support surface 100 when the rotation mechanism 300 supports the rotating globe shell 200 upon the support surface 100. In particular embodiments, the support surface 100 may have a surface area substantially equal to or only slightly greater than a surface area of the lower surface 346 of the support platform 342.

Both the lower surface 346 of the support platform 342 and the support surface 100 may be substantially planar and horizontal. However, as is apparent to those of ordinary skill, the support platform 342 may have any shape and the invention is not limited by the shape of the support platform 342.

The rotation mechanism 300 may include a motor 332 coupled nonrotatably to the housing 206 of the rotating globe shell 200. In the embodiment depicted in FIG. 2, the motor 332 is coupled nonrotatably to the inside of the lower hollow portion 214 of the hollow portion 212 of the rotating globe shell 200. However, as is apparent to those of ordinary skill, in alternate embodiments, the motor 332 may be coupled to the upper hollow portion 216 and such embodiments are within the scope of the present invention. Because locating the motor 332 in the lower hollow portion 214 may lower the center of gravity of the rotating globe shell 200, in some embodiments, it may be preferable to locate the motor 332 in the lower hollow portion 214.

The motor 332 may be nonrotatably coupled to the housing 206 in any manner known in the art for coupling a motor to the inside surface of a hollow object such that a body 334 of the motor cannot rotate relative to the hollow object. In the embodiment depicted in the drawings, the lower hollow portion 214 of the hollow portion 212 includes a motor anchor sleeve 224 within the interior of the lower hollow portion 214 along the axis 222. The motor anchor sleeve 224 may be molded as an integral part of lower hollow portion 214. The anchor sleeve 224 may have a lower end portion 226 attached to the lower hollow portion 214 and an upper end portion 228 having an upwardly opening interior chamber 229 with an opening 230 sized to receive the body 334 of the motor 332 therethrough for positioning in the interior chamber.

In various embodiments, the body 334 of the motor 332 may be pressed through the opening 230 of the interior chamber 229 of the anchor sleeve 224 to provide an interference fit within the interior chamber so as to prevent relative rotational movement between the motor body 334 and the lower hollow portion 214. Alternatively, the motor body 334 may be molded into the anchor sleeve 224 or fastened thereto in any manner known in the art. In particular embodiments, one of the motor body 334 and the anchor sleeve 224 may include one or more projections that are received into corresponding recesses formed in the other of the motor body 334 and the anchor sleeve 224.

The motor 332 may be coupled to and powered by any autonomous power source (not shown) known in the art such as one or more batteries, solar panels, and the like. The autonomous power source may be retained within the housing 206 so as to be invisible to a person viewing the assembled rotating globe shell 200 from the exterior. Alternatively, one or more solar panels may be mounted to the outside surface 202 of the rotating globe shell 200 to provide power to the motor 332 of the rotation mechanism 300.

The motor 332 has a rotational output shaft 336 extending downward from the motor body 334 along the axis 222. The output shaft 336 may engage a thrust bearing 338 also aligned with the axis 222 that facilitates rotation of the lower hollow portion 214 relative to the output shaft 336. The thrust bearing 338 may absorb forces, such as thrusts, parallel to the vertical axis of rotation 222. The thrust bearing 338 may be positioned in an inwardly and upwardly opening recess 239 in the lower hollow portion 214 aligned with the axis 222, within the lower end portion 226 of the anchor sleeve 224. The recess 239 is sized to receive and hold the thrust bearing 338 therein.

In embodiments in which the housing 206 includes a solid lower portion, the motor body 334 may be molded into the solid lower portion and a channel (not shown) formed along the axis 222 between the motor 332 and the aperture 210. The channel may include a wider portion or void sized and shaped to house the thrust bearing 338. In this manner, the output shaft 336 may extend from the motor 332 through the channel and exit the interior 208 of the housing 206 via the aperture 210 whereat a distal end 340 of the output shaft 336 may be attached to the upper surface 345 of the support platform 342.

The aperture 210 may be located within the recess 239 and a lower end portion or distal end 340 of the output shaft 336 may exit the interior 208 of the housing 206 via the aperture 210. The distal end 340 may be securely and non-rotatably attached to the support platform 342 using any suitable known means.

The outside surface 202 of the housing 206 may include an outwardly and downwardly opening recess 244 aligned with the axis 222 and sized to receive the majority portion 348 of the support platform 342 and allow the housing 206 to rotate freely about the support platform 342 which is nestled within the recess 244 within the lower hollow portion in close proximity to the support surface 100. In the embodiment depicted in FIG. 2, the recess 244 is formed in the lower hollow portion 214. As is apparent to those of ordinary skill, a minority portion 350 of the support platform 342 may be exterior to the recess 244 to space the housing 206 supported thereby a suitable distance from the support surface 100.

It may be desirable to shape and size the minority portion 350 to minimize its visibility when the support platform 342 is engaging the support surface 100. When positioned upon the support surface 100, the support platform 342 and the recess 244 may be positioned and sized to be essentially invisible to a person viewing the rotation mechanism 300 and rotating globe shell 200 coupled thereto. The support platform 342 may be sized and shaped to provide sufficiently stable support for the rotating globe shell 200 as the housing 206 is rotated about the axis 222 by the motor 332 so that it does not fall over.

When electrical power is applied to the motor 332, rotational drive is applied to the output shaft 336. Surface interaction forces, such as friction, between the lower surface 346 of the support platform 342 and the support surface 100 resist the rotation of the lower surface 346 relative to the support surface 100. The lower surface 346 of the support platform 342 frictionally engages the support surface 100 with sufficient force to prevent rotation of the lower surface 346 (and therefore the support platform 342) relative to the support surface 100, thus causing the motor body 334 to rotate relative to the support surface 100 while the output shaft 336 remains stationary relative to the support surface 100.

In other words, while the motor 332 applies rotational drive force to the output shaft 336, frictional forces between the support surface 100 and the support platform 342 resist this rotational drive force and maintain the support platform 342 and hence the output shaft 336 coupled thereto in a substantially stationary position. The frictional force between the lower surface 346 of the support platform 342 and the support surface 100 is at least as great as the rotational force applied to the output shaft 336 by the motor 332, thereby preventing the support platform 342 from rotating relative to the support surface 100. As a result, the motor body 334 and housing 206 nonrotatably coupled thereto rotate about the output shaft 336 and the support platform 342 and the support surface 100 as a unit.

With respect to the embodiment depicted in FIG. 2, the motor body 334 and motor anchor sleeve 224 of the lower hollow portion 214 nonrotatably coupled thereto rotate about the stationary output shaft 336 and support platform 342. Because the motor body 334 is nonrotatably attached to the motor anchor sleeve 224, which is attached to the lower hollow portion 214, the rotational drive applied to the output shaft 336 causes the lower hollow portion 214 to rotate relative to the output shaft 336 and the support surface 100. The lower hollow portion 214 may be attached to the upper hollow portion 216 so that the two will rotate together as a unit. This provides a pleasing illusion that the rotating globe shell 200 is turning about the axis 222 without any visible means for doing so.

In the embodiment depicted in FIG. 2, both the lower surface 346 of the support platform 342 and the support surface 100 are planar. In alternate embodiments, the lower surface 346 and support surface 100 may each include a contour (not shown). FIG. 2 depicts an embodiment of the support surface 100 that is substantially planar and horizontal. In alternate embodiments, the support surface 100 is curved, the contour of the lower surface 346 may correspond to and mate with the contour of the curved support surface 100. Further, one of or both the lower surface 346 and support surface 100 may include a texture to increase the frictional forces that resist rotation and slippage between the lower surface 346 and support surface 100.

In the embodiments depicted in the drawings, the rotational drive force of the motor 332 is resisted only by the surface interaction forces, such as friction, between the lower surface 346 and support surface 100. While the contour of the lower surface 346 may correspond to and mate with the contour of the support surface 100, neither contour is configured to resist or interfere with the free movement of the lower surface 346 relative to the support surface 100. Specifically, neither contour resists or interferes with the rotation drive force applied to the output shaft 336 and translated to the support platform 342. Neither of the lower surface 346 and support surface 100 include projections (such as pegs) received into the other of the lower surface 346 and support surface 100. Further, no securing or fastening means is present between the lower surface 346 and support surface 100.

As is apparent to those of ordinary skill, the size and shape of the support platform 342 and the corresponding support surface 100 may determine the size and/or shape of rotating globe shell 200. If the rotating globe shell 200 is asymmetric about the axis 222 of rotation, stability may be increased by using a larger support platform 342.

The motor may include any electric motor capable of producing enough torque to rotate the rotating globe shell 200 using power obtained from the autonomous power source.

As is appreciated by one of ordinary skill, globe shells are produced in a large range of sizes. Consequently, as is appreciated by those of ordinary skill in the art, the size and shape of the support platform 342 and rotating globe shell 200 may be determined by the needs of the party constructing the motor driven globe 10.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

The invention claimed is:

1. A display article for viewing by an observer while the display article rests upon a support surface comprising:
a motor having a motor body, the motor being configured to generate a predetermined amount of rotational drive force;
a support platform located below the motor and aligned vertically therewith, the support platform having a lower surface frictionally engaging the support surface;
a vertical shaft having an upper end coupled to the motor to receive the predetermined amount of rotational drive force generated by the motor and a lower end nonrotatably coupled to the support platform, the vertical shaft being configured to allow the motor body to rotate freely about the vertical shaft when the motor is generating the predetermined amount of rotational drive force, thereby maintaining the support platform and the vertical shaft nonrotatably coupled thereto in a stationary position and causing the motor body to rotate freely about the vertical shaft when the motor is generating the predetermined amount of rotational drive force; and
a rotating article concealing and nonrotatably coupled to the motor body, the rotating article being supported above the support surface by the vertical shaft and configured to rotate with the motor body when the motor body is rotated about the vertical shaft, the rotating article having a recess configured to receive therein and conceal a majority portion of the support platform rendering the support platform substantially invisible to the observer.

2. The globe of claim 1, wherein the motor is concealed inside the rotating article, the rotating article comprises:
a hollow housing having a lower hollow portion with an inside surface;
a motor anchor sleeve nonrotatably coupled to the inside surface of the lower hollow portion, the motor anchor sleeve having an interior into which the motor body is received, the interior being configured to retain the motor body and prevent rotation between the motor body and the lower hollow portion when the motor body is rotating about the vertical shaft; and
an aperture extending vertically between the interior of the motor anchor sleeve and the recess of the rotating article, the vertical shaft extending between the motor concealed inside the rotating article and the support platform located within the recess of the rotating article through the aperture.

3. The globe of claim 1, wherein the motor is concealed inside the rotating article, and the rotating article comprises a removable upper hollow portion configured to be removable to allow access to the motor.

4. The globe of claim 1 for use with a planar and substantially horizontal support surface, wherein the lower surface of the support platform is planar and substantially horizontal.

5. The globe of claim 1, wherein a vertical thrust force is exerted on the rotating article, the motor is concealed inside the rotating article, the rotating article comprises:
a hollow housing having a lower hollow portion with an inside surface and a removable upper hollow portion configured to be removable to allow access to the motor;
a motor anchor sleeve nonrotatably coupled to the inside surface of the lower hollow portion, the motor anchor sleeve having an interior into which the motor body is received, the interior being configured to retain the motor body and prevent rotation between the motor body and lower hollow portion when the motor body is rotating about the vertical shaft; and
an aperture extending vertically between the interior of the motor anchor sleeve and the recess of the rotating article, the vertical shaft extending between the motor concealed inside the rotating article and the support platform located inside the recess of the rotating article through the aperture; and
the rotation mechanism includes a thrust bearing disposed inside the motor anchor sleeve adjacent to the aperture, the thrust bearing being configured to absorb a portion of the vertical thrust force exerted on the rotating article.

6. A display article for viewing by an observer while the display article rests upon a support surface comprising:
a rotating article comprising an outer surface, an interior, and a recess formed in the outer surface with an aperture in communication with the interior of the rotating article; and
a rotation mechanism housed in the interior of the rotating article and supporting the rotating article upon the support surface, the rotation mechanism comprising:
a downwardly extending output shaft having a portion housed within the interior of the rotating article and a distal end exiting the interior through the aperture and terminating within the recess;
a support platform having a majority portion disposed within the recess, with a top surface attached to the distal end of the output shaft, and a lower surface exterior to the recess being frictionally engaged with the support surface;
a motor housed within the interior of the rotating article and rotationally coupled to the portion of the output shaft housed within the interior of the rotating article and configured to apply a rotational force thereto, the motor comprising a motor body nonrotationally coupled to the interior of the rotating article;
wherein friction between the lower surface of the support platform and the support surface prevents the support platform from rotating relative to the support surface when the motor applies the rotational force to the portion of the output shaft housed within the interior of the rotating article and causes the motor body of the motor and the rotating article nonrotationally coupled thereto to rotate about the output shaft as a unit.

7. The globe of claim 6 for use with a planar and substantially horizontal support surface, wherein the lower surface of the support platform is planar and substantially horizontal.

8. The globe of claim 6, wherein the rotating article comprises:
a hollow housing having a lower hollow portion with an inside surface;
a motor anchor sleeve within the lower hollow portion and nonrotatably coupled thereto, the motor anchor sleeve having an interior into which the motor body is received, the interior being configured to retain the motor body and prevent rotation between the motor body and lower hollow portion when the motor body is rotating about the vertical shaft; and
the aperture of the recess formed in the outer of the rotating article extends between the recess and the interior of the motor anchor sleeve.

9. The globe of claim 6, wherein the rotating article comprises a removable upper hollow portion configured to be removable to allow access to the motor inside the interior of the rotating article.

10. The globe of claim 6 for use with a support surface having a first surface area, wherein the lower surface of the support platform has a second surface area, and the first surface area being substantially equal to the second surface area.

11. A display article for viewing by an observer while the display article rests upon a support surface comprising:
a rotating article having an interior, an axis of rotation, a lower portion, and a recess formed in the lower portion along the axis of rotation; and
a rotation mechanism configured to generate a rotational force about the axis of rotation of the rotating article, the rotation mechanism comprising:
a support platform substantially concealed within the recess of the lower portion and having a lower surface frictionally engaged with and resting upon the support surface; and
a motor rotationally coupled to the support platform along the axis of rotation, and configured to apply a rotational drive force to the support platform, the motor having a motor body nonrotationally coupled to the interior of the rotating article and configured to rotate about the axis of rotation when the motor applies the rotational drive force to the support platform and thereby rotates the rotating article to which the rotating motor body is coupled about the axis of rotation.

12. The globe of claim 11 for use with a planar and substantially horizontal support surface, wherein the lower surface of the support platform is planar and substantially horizontal.

13. The globe of claim 11, wherein the rotating article comprises:
a hollow housing having a lower hollow portion with an inside surface;
a motor anchor sleeve nonrotatably coupled to the inside surface of the lower hollow portion, the motor anchor sleeve having an interior into which the motor body is received, the interior being configured to retain the motor body and prevent rotation between the motor body and lower hollow portion when the motor body is rotating about the vertical shaft; and
an aperture extending vertically between the interior of the motor anchor sleeve and the recess of the rotating article, the vertical shaft extending between the motor in the interior of the rotating article and the support platform located within the recess of the rotating article through the aperture.

14. The globe of claim 11, wherein the rotating article comprises a removable upper portion configured to be removable to allow access to the motor.

15. A display article disposed on a support surface comprising:
a rotating article having an interior and an axis of rotation; and
a rotation mechanism configured to generate a rotational force about the axis of rotation of the rotating article, the rotation mechanism including a motor housed within the interior of the rotating article and rotationally coupled to the support portion along the axis of rotation to apply a rotational drive force to the support portion, the motor having a motor body nonrotationally coupled to the interior of the rotating article and configured to rotate about the axis of rotation when the motor applies the rotational drive force to the support portion and thereby rotates the rotating article to which the rotating motor body is coupled about the axis of rotation relative to the support portion.

16. The globe of claim 15, wherein the rotating article has a recess formed in a lower portion thereof along the axis of rotation, and the motor is rotationally coupled to the support portion through a support platform that frictionally engages the support portion with the support platform at least partially positioned within the recess.

17. The globe of claim 16, wherein the rotating article includes a motor anchor sleeve nonrotatably coupled to the lower portion thereof, the motor anchor sleeve having an interior into which the motor body is received, the interior being configured to retain the motor body and prevent rotation between the motor body and lower portion when the motor body is rotating about the axis of rotation.

18. The globe of claim 17, further including an aperture extending between the interior of the motor anchor sleeve and the recess of the rotating article, and the rotation mechanism includes a motor shaft by which the motor body is rotationally coupled to the support portion along the axis of rotation to apply the rotational drive force to the support portion, the motor shaft extending between the motor body in the motor anchor sleeve and the support platform located within the recess of the rotating article through the aperture.
